(19) United States
(12) Patent Application Publication
(10) Pub. No.: US 2024/0157941 A1
(43) Pub. Date: May 16, 2024

(54) METHOD AND DEVICE FOR SUPPORTING AN ANTI-LOCK BRAKING SYSTEM

(71) Applicant: Robert Bosch GmbH, Stuttgart (DE)

(72) Inventors: Herbert Vollert, Vaihingen/Enz (DE); Michael Kunz, Steinheim An Der Murr (DE)

(21) Appl. No.: 18/501,544

(22) Filed: Nov. 3, 2023

(30) Foreign Application Priority Data
Nov. 10, 2022 (DE) 10 2022 211 896.0

(51) Int. Cl. B60W 30/18; B60L 15/20; B60W 10/08; B60W 10/184

(52) U.S. Cl. CPC B60W 30/18109; B60L 15/2009; B60W 10/08; B60W 10/184; B60L 2240/12; B60L 2240/423; B60L 2240/461; B60W 2520/10; B60W 2520/28; B60W 2710/083; B60W 2710/18

(57) ABSTRACT

A method and device for supporting an anti-lock braking system in a motor vehicle. In the method, the presence of a locked or nearly locked wheel of the motor vehicle is ascertained, and if a locked wheel is present, a wheel drive force is exerted on this wheel in a targeted manner.

### BACKGROUND INFORMATION

German Patent Application No. DE 10 2010 038 563 A1 relates to a method for reducing the traction slip of vehicle wheels driven by different motors. Traction slip can be provided particularly simply and cost-effectively if a slip control is performed on a first group of wheels driven by a first motor and if a control of the drive torque is performed on a second group of wheels driven by a second motor.

### SUMMARY

The present invention relates to a method for supporting an anti-lock braking system in a motor vehicle. According to an example embodiment of the present invention, the method includes:
the presence of a locked or nearly locked wheel of the motor vehicle is ascertained, and,
if a locked wheel is present, a wheel drive force is exerted on this wheel in a targeted manner.

In an advantageous embodiment of the present invention, a wheel is detected as being nearly locked if the difference between the current wheel speed and the longitudinal speed of the motor vehicle exceeds a specified threshold value.

In an advantageous embodiment of the present invention, the threshold value is only slightly lower than the longitudinal speed of the motor vehicle. In this case, the vehicle wheel only rotates very slowly and the vehicle wheel is in the range of dynamic friction.

In an advantageous embodiment of the present invention, the wheel drive force is exerted via a wheel drive motor assigned to the locked or nearly locked wheel. The wheel drive motor may in particular be an electric motor or an electric wheel hub motor.

In an advantageous embodiment of the present invention, for each driven wheel, the motor vehicle has a wheel drive motor assigned to the respective wheel.

In an advantageous embodiment of the present invention, in the event that the locked or nearly locked wheel is on a wheel axle having a transverse differential, the wheel drive force is exerted by braking the wheel opposite the locked or nearly locked wheel.

In an advantageous embodiment of the present invention, the wheel drive force is exerted until the wheel speed has reached a specified threshold value, so that the wheel increasingly reaches the range of static friction again and can thus transmit a higher braking force to the roadway.

In an advantageous embodiment of the present invention, the wheel drive force is exerted until the wheel speed has reached the value of the longitudinal speed of the motor vehicle.

Furthermore, the present invention includes a device, including means designed to perform the methods according to the present invention. This is in particular a control unit in which the program code for performing the methods according to the present invention is stored.

### BRIEF DESCRIPTION OF THE DRAWING

FIG. 1 shows a basic flow of an example embodiment of the method according to the present invention.

### DETAILED DESCRIPTION OF EXAMPLE EMBODIMENTS

Conventional ABS or anti-lock braking systems have the property that the braking force on a wheel can only be reduced to zero, i.e., an unbraked state. This means that in the case of a so-called wheel run-in, i.e., the wheel rotates significantly slower than the vehicle travels, re-acceleration of an overbraked wheel to the vehicle speed must take place merely via the dynamic friction between the wheel and the road and via the inertia of the wheel.

This problem can be identified very easily by means of a thought experiment. If the friction between the wheel and the road is very low, e.g., icy water, the force that can be applied by the road surface to a locked wheel is very low in the case of a moving vehicle and the wheel thus takes a very long time to resume the speed of the vehicle. This is also related to the fact that the inertia of the wheel does not change with different roadways.

Some types of drive of motor vehicles allow the individual wheels of the motor vehicle to be supported in accelerating individual wheels.

On the basis of a motor vehicle with 4 electric motors or wheel drive motors or wheel hub motors, wherein each of the motors is assigned to a different wheel, the present invention is presented as follows:

If overbraking occurs on a wheel as a result of the braking system, i.e., the wheel is locked or nearly locked, the ABS controller can instruct the drive of this wheel to increase the speed of the wheel. This is to achieve that the friction pairing between this wheel and the roadway surface moves away from dynamic friction toward static friction. The speed of this wheel may be increased either to the vehicle speed or even only to a speed that is still below the vehicle speed. In this way, the wheel can achieve a high braking force faster again and the braking distance can thus be shortened. The ascertainment of the vehicle speed may need to be supported via the output signals of further sensors since locked wheels can have a disruptive influence on the ascertainment of the vehicle speed, depending on the method used to ascertain the vehicle speed.

The solution can be designed in different architectures:
There is a traditional braking system which has communication to the drive(s) of the vehicle and the latter can drive individual wheels in a targeted manner. The braking system instructs the drive to adjust the rotational speed of the wheel.
It is also possible that the ABS directly cooperates with the drive and, for example, ensures that the rotational speed of a locked or nearly locked wheel is increased again via the combination of the drive and the braking force on the opposite wheel and thus allows a higher braking force. It would also be possible to transfer this task to a central computer. The latter then assumes the control or communication to the braking and drive system.

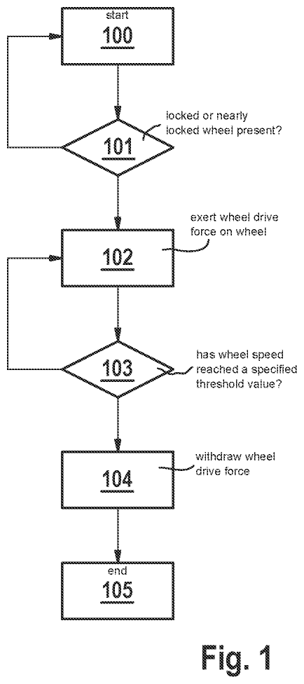

FIG. 1 shows the basic flow of an example embodiment of the method according to the present invention.

After the start of the method in block 100, it is checked in block 101 whether a locked or nearly locked wheel of the motor vehicle is present. If this is not the case, a return to block 100 takes place. However, if a locked or nearly locked wheel is present, a wheel drive force is exerted on this wheel in a targeted manner in block 102. Subsequently, in block 103, it is checked whether the wheel speed thereof has again reached a specified threshold value. If this is not the case, a return to block 102 takes place and a wheel drive force continues to be exerted. However, if the wheel speed has reached the threshold value, the wheel drive force is withdrawn in block 104 and the method ends in block 105.

1-10. (canceled)

11. A method for supporting an anti-lock braking system in a motor vehicle, comprising:
ascertaining a presence of a locked or nearly locked wheel of the motor vehicle; and
exerting, based on a locked or nearly locked wheel being present, a wheel drive force on the wheel in a targeted manner.

12. The method according to claim 11, wherein a wheel is detected as being nearly locked when a difference between a current wheel speed and a longitudinal speed of the motor vehicle exceeds a specified threshold value.

13. The method according to claim 12, wherein the threshold value is only slightly lower than the longitudinal speed of the motor vehicle.

14. The method according to claim 11, wherein the wheel drive force is exerted via a wheel drive motor assigned to the locked or nearly locked wheel.

15. The method according to claim 14, wherein a drive motor of the wheel is an electric motor.

16. The method according to claim 14, wherein, for each respective driven wheel of the motor vehicle, the motor vehicle has a wheel drive motor assigned to the respective driven wheel.

17. The method according to claim 11, wherein, in the event that the locked or nearly locked wheel is on a wheel axle having a transverse differential, the wheel drive force is exerted by braking a wheel opposite the locked or nearly locked wheel.

18. The method according to claim 11, wherein the wheel drive force is exerted until a wheel speed has reached a specified threshold value.

19. The method according to claim 11, wherein the wheel drive force is exerted until a wheel speed has reached a value of the longitudinal speed of the motor vehicle.

20. A device configured to support an anti-lock braking system in a motor vehicle, the device configured to:
ascertain a presence of a locked or nearly locked wheel of the motor vehicle; and
exert, based on a locked or nearly locked wheel being present, a wheel drive force on the wheel in a targeted manner.
